(19) United States
(12) Patent Application Publication
(10) Pub. No.: US 2010/0200698 A1
(43) Pub. Date: Aug. 12, 2010

(54) FUSELAGE AND A METHOD FOR REDESIGNING IT

(75) Inventors: Gennady Trofimovich Kreshchishin, Moscow (RU); Larisa Trofimovna Kreschishina, Moscow (RU)

Correspondence Address: PATENTTM.US, P. O. BOX 82788, PORTLAND, OR, 97282-0788, US

(73) Assignee: Gennady Trofimovich KRESHCHISHIN, Moscow (RU)

(21) Appl. No.: 12/676,360

(22) PCT Filed: Sep. 12, 2008
(86) PCT No.: PCT/RU2008/000592

§ 371 Date: Mar. 3, 2010

(30) Foreign Application Priority Data
Sep. 14, 2007 (RU) 2007134266

(51) Int. Cl. B64C 1/38

(52) U.S. Cl. 244/130

(57) ABSTRACT

The invention relates to aircraft engineering for improving aerodynamic quality of helicopters, aeroplanes, including traditionally designed airbuses and amphibian airplanes, aerodynamic ground-effect and air-cushion vehicles, possibly by redesigning said transportation means. Flying drag is reduced, possibly by redesigning aircraft, helicopters, ground-effect crafts and air-cushion vehicles. Result is achievable by reducing a contacting area between the external surface of fuselage tail section and a high-speed air flow. Contacting area is reduced by increased area of orifices in fuselage tail section. To increase lifting force without increasing pressure resistance, the aerodynamic channel bottom is designed convex upwards, for example curved upwards along the shape of convex side of airfoil section. The aerodynamic channel skin top orifice can be located under tail fin middle part and lengthwisely divided by said fin to the right and left, for example in two. Redesign enables reducing fuselage total drag, reducing required engine thrust.

### FIELD OF THE INVENTION

This invention relates to the field of aeronautical engineering and is applicable for improving the aerodynamic behavior of helicopters, aircraft, including large airbuses of classical design and amphibian airplanes, rain wing surface-effect vehicles and air-cushion vehicles, possibly by redesigning them.

### BACKGROUND ART

The fuselage of a cargo airplane, a large airbus of classical design or an amphibian airplane is usually made as a torpedo-shaped body of circular cross-section with the elongation (length to diameter ratio) from 6 to 12. The laminar boundary layer in the forward fuselage gradually transforms into a turbulent one and flows without separation from the fuselage rear section as air-flow swirls creating their part of the flying drag of an airplane, helicopter, air-cushion vehicle. In order to attain a smooth air flow in the fuselage boundary layer the fuselage tail-end is made so as the cross-section diameter smoothly decreases toward the fuselage end, which does not preclude the beginning of the deflector effect and increases turbulence and an air-flow swirl around and along the tail section in comparison to the cylindrical section of the fuselage. In order to prevent the fuselage tail-end from touching the runway surface during takeoff or landing, the fuselage tail-end is made obliquely raised against the constructional horizontal (i.e., a horizontal plane along the fuselage longitudinal axis), which increases air-flow swirls in the lower area of the tail section. A free space of the narrowing inclined section of the fuselage is filled poorly, since it is inconvenient for accommodating cargo or passengers (see, Aviatransportnoye Obozreniye Magazine, No. 68, April 2006, p. 6, External Appearance of Boeing 737-800).

Steadily rising prices for aviation fuels make the conventional airplanes of classical designs noncompetitive compared to the modern Boeing 777 and Airbus A380 airplanes.

A fuselage is known that comprises a cylindrical cargo-and-passenger cabin separated by a sealing partition from the tail section narrowing toward the fuselage tail-end, the partition having holes and an inclined bent aerodynamic channel. The upper hole in the skin is formed as an air inlet ahead of the tail fin over the fuselage and is connected to the upper front edge of the aerodynamic channel by smooth round-offs. The inclination in the middle portion of the aerodynamic channel is provided by the latter's steep zigzag bend, and the rectilinear horizontal portion is prolonged up to the end inside the fuselage. The lower rear edge of the aerodynamic channel is aligned with a hole in the fuselage end, which is made as a cut in the tail section. The aerodynamic channel is used as an air conduit for an aviation engine arranged in the fuselage tail section (see, T. I. Ligum et al., TU154B Airplane Aerodynamics. Moscow, Transport Publishers, 1985). The fuselage tail section is rather complex and does not provide for a reduction in the aerodynamic drag and an increase in the lifting force of the fuselage tail section.

### SUMMARY OF THE INVENTION

The technical task is to reduce flying drag, possibly due to redesigning of an airplane, helicopter, rain wing surface-effect vehicle or air-cushion vehicle.

A technical effect can be achieved due to decreasing the area of contact between the fuselage tail external surface and a high-velocity air flow, for which purpose the said area of contact is reduced by increasing the surface area of holes made in the fuselage tail section; in order to increase the lifting force without increasing the pressure drag, the bottom of the aerodynamic channel is made convex upwards, for example, convex upwards according to the form of the aerodynamic profile convex side. The lateral surfaces of the aerodynamic channel may rest on the tail section skin. A stabilizer with an elevator may be attached to the robust frame of the tail section externally on the skin sides. The upper hole in the tail section skin, which is aligned by round-offs with the front edge of the aerodynamic channel, may be made under the middle portion and on the both sides of the tail fin which rear support is fixed on the tail rear end raised upwards, wherein the said rear end may be made in the form of a wing, in particular in the form of an upturned asymmetrical aerodynamic profile. The upper hole in the skin may be limited in length to a distance from the sealing partition of the passenger cabin to the rear support of the fin, and in width—archwisely, according to the skin form within the points of attaching to the stabilizer skin. The upper front hole in the skin may be made with a larger surface area than a hole formed by a cut in the tail end.

### BRIEF DESCRIPTION OF THE DRAWINGS

In the drawings:

FIG. 1 shows the fuselage tail section, lateral view;

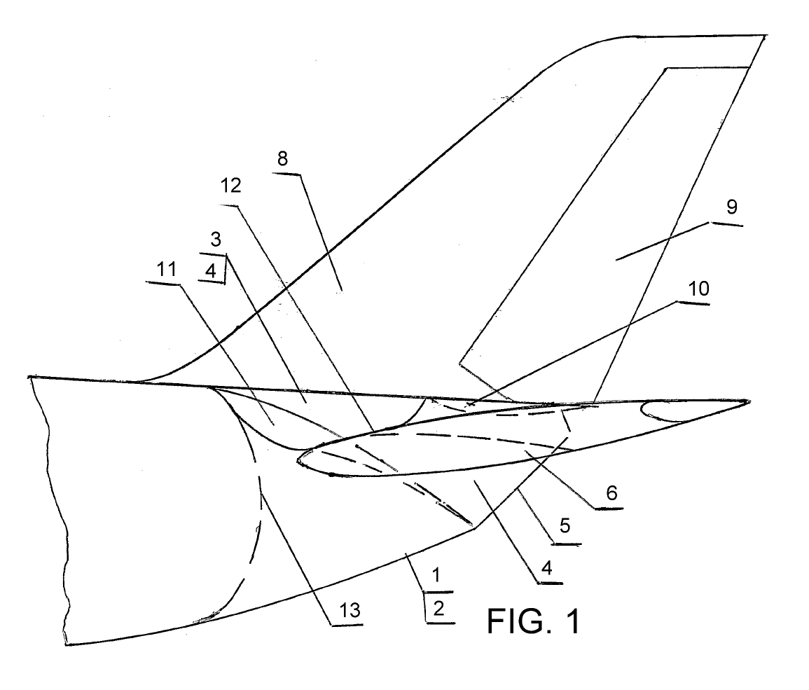

FIG. 2 shows the fuselage tail section, top view.

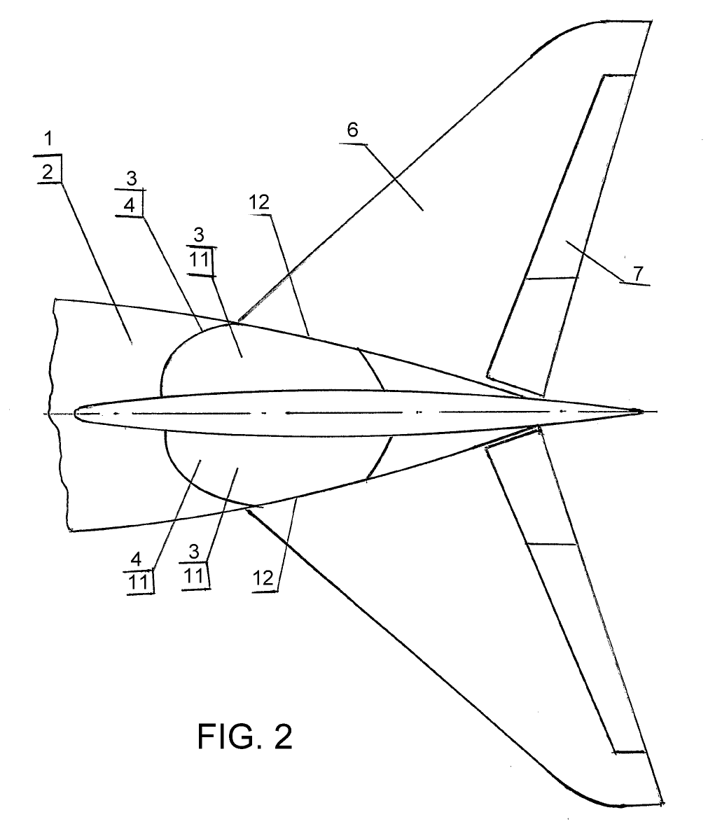

### DESCRIPTION OF A PREFERRED EMBODIMENT

Holes and an inclined aerodynamic channel are made in the fuselage tail section 1. The aerodynamic form of the tail section 1 is created by the skin 2 attached to a robust frame; a hole 3 is made in the upper part of the skin, which is aligned with the upper edge of the inclined aerodynamic channel 4 which lower edge is aligned with a hole 5 made as a cut in the end of the tail section 1. The robust frame inside the tail section 1 firmly rests on the skin 2, forming a single whole therewith. A stabilizer 6 with an elevator 7 is attached to the robust frame on the sides of the skin 2, and a fin 8 with a rudder 9 is attached to the robust frame on the top of the skin 2. The top 10 of the tail section 1 may be made as a wing, including that having an asymmetrical aerodynamic profile, possibly upturned, with downward curvature also called profile negative curvature. The bottom 11 of the aerodynamic channel 4 is made convex upwards, e.g., it is bent according to the convex side of the aerodynamic profile. The hole 3 in the skin 2 is bent according to the form of the skin 2 and may be made oval, separated lengthwise to the right and to the left, for example, in half by the fin 8, and the bend and the width of the hole 3 may be limited by the upper surface 12 of the stabilizer 6, and the length of the hole 3 may be limited by the distance from the sealing partition 13 of the passenger cabin to the wing 10. The hole 3 may be located under the middle portion of the fin 8. The hole 3 may have a greater surface area than the hole 5 with a cut in the end of the tail section 1, and the lateral surfaces of the aerodynamic channel 4 may rest on the skin 2 of the tail section 1.

According to the proposed redesigning the holes 3 and 5 in the skin 2 are made enlarged and are connected by the aerodynamic channel 4 bent upwards, as said above; in the result the area of contact between the external surface of the skin 2 and a high-velocity air flow and its boundary layer is reduced. An air flow in the aerodynamic channel 4 can move with a velocity that is much lower than an air flow velocity in the boundary layer on the external skin 2, so the air flow friction drag in the aerodynamic channel 4 is many times less than the air flow friction drag in the boundary layer of the air flow on the external surface of the skin 2, and the friction drag of the fuselage tail section 1 is reduced accordingly after the proposed redesigning of the existing fuselages of classical form. The surface of the bottom 11 of the aerodynamic channel 4, which is smoothly bent according to the aerodynamic profile form and, possibly, is curved upwards on the lateral sides, contributes to a reduction in the total air flow resistance in the aerodynamic channel 4 and to an increase of the lifting force in the aerodynamic channel.

An airplane of classical form may have the external skin friction drag in the range from 70% to 80% of the total airplane drag, and a share of the pressure drag is in the range from 15% to 26% of the total airplane drag, that is a significantly less part of the total airplane drag, which, however, creates the whole 100% of the airplane wing lifting force and overcomes the profile drag of the airplane forward and tail sections. Since the profile of the tail section 1 of an airplane of classical form has a negative curvature, the air pressure under the bottom of the tail section 1 and the hole 5 is less than the air pressure over the top of the tail section 1 and the hole 3, and this pressure difference pushes the airplane tail section down during the flight. Therefore, the greater are the holes 3 and 5, the less are a pressure drag and a lifting force loss of an airplane due to the fact that the airplane tail section 1 is bent upwards. As a result, the proposed redesigning will ensure a reduction in the airplane total drag and the corresponding reduction in the required aviation engine thrust.

What is claimed is:

1. A fuselage having an inclined aerodynamic channel and holes aligned with edges of said aerodynamic channel, wherein the rear hole is made as a cut in the end of the fuselage tail section, characterized in that at least one hole is made in the area of the middle portion of the fin tail support which rear support is fixed in the tail section rear end raised upwards.

2. A fuselage according to claim 1, characterized in that the top of the tail section end is made as a wing having an asymmetrical aerodynamic profile, for example, with the convex lower side.

3. A fuselage according to claim 1, characterized in that the bottom of the said aerodynamic channel is convex upwards, for example is bent upwards according to the form of the aerodynamic profile convex side.

4. The tail section of an airplane according to claim 2, characterized in that the upper hole in the skin is limited by a distance from the partition to the passenger cabin to the said wing and is limited by width archwisely according to the skin form within the limits of points of attaching to the stabilizer skin.

5. The tail section of an airplane according to claim 1, characterized in that a hole in the fuselage near the fin middle section is made so as to have the surface area greater than that of the hole made as a cut in the tail section end.

6. A fuselage according to claim 4, characterized in that the lateral surfaces of the said aerodynamic channel rest on the skin.

7. A method of redesigning a fuselage for reducing its total drag, consisting in that the area of contact between its skin and a high-velocity air flow is reduced, for which purpose at least one hole having edges rounded inwards is made in the upper portion of the skin, and another hole is made as a cut in the tail section end, said holes being connected by the said aerodynamic channel.
